(19) United States
(12) Patent Application Publication
(10) Pub. No.: US 2019/0317048 A1
(43) Pub. Date: Oct. 17, 2019

(54) SYSTEMS AND METHODS TO REMOTELY MANAGE NON-DESTRUCTIVE TESTING SYSTEMS

(71) Applicant: Illinois Tool Works Inc., Glenview, IL (US)

(72) Inventors: Sakif B. Ferdous, Skokie, IL (US); Wyatt M. Burns, Woodridge, IL (US); Justin J. Stewart, DeWitt, IA (US)

(21) Appl. No.: 16/385,561

(22) Filed: Apr. 16, 2019

Related U.S. Application Data
(60) Provisional application No. 62/659,002, filed on Apr. 17, 2018.

(51) Int. Cl. G01N 27/82; G01N 15/08

(52) U.S. Cl. CPC G01N 27/82; G01N 15/0806

(57) ABSTRACT

Systems and methods to remotely manage non-destructive testing systems are disclosed. An example NDT system includes: a test process manager configured to: receive a configuration of a magnetic particle test procedure or a penetrant test procedure corresponding to a part type; and store the magnetic particle test procedure or the penetrant test procedure; and a magnetic particle inspection device or penetrant testing device, including: a communications device configured to receive the magnetic particle test procedure or the penetrant test procedure from the test process manager via a communications network; a processor; and a memory coupled to the processor and storing machine readable instructions to: in response to identification of the part type as a part under test, access the magnetic particle test procedure or the penetrant test procedure based on the identification; and control a testing process based on the magnetic particle test procedure or the penetrant test procedure.

### RELATED APPLICATIONS

This patent claims priority to U.S. Provisional Patent Application Ser. No. 62/659,002, filed Apr. 17, 2018, entitled “SYSTEMS AND METHODS TO REMOTELY MANAGE NON-DESTRUCTIVE TESTING SYSTEMS.” The entirety of U.S. Provisional Patent Application Serial No. 62/659,002 is incorporated herein by reference.

### FIELD OF THE DISCLOSURE

This disclosure relates generally to non-destructive testing and, more particularly, to systems and methods to remotely manage non-destructive testing systems.

### BACKGROUND

Non-destructive testing (NDT) is used to evaluate properties and/or characteristics of material, components, and/or systems without causing damage or altering the tested item. Because non-destructive testing does not permanently alter the article being inspected, it is a highly valuable technique, allowing for savings in cost and/or time when used for product evaluation, troubleshooting, and research. Frequently used non-destructive testing methods include magnetic-particle inspections, eddy-current testing, liquid (or dye) penetrant inspection, radiographic inspection, ultrasonic testing, and visual testing. Non-destructive testing (NDT) is commonly used in such fields as mechanical engineering, petroleum engineering, electrical engineering, systems engineering, aeronautical engineering, medicine, art, and the like.

Further limitations and disadvantages of conventional approaches will become apparent to one management of skill in the art, through comparison of such approaches with some aspects of the present method and system set forth in the remainder of this disclosure with reference to the drawings.

### SUMMARY

Systems and methods to remotely manage non-destructive testing systems are disclosed.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 shows an example magnetic particle testing system configured to use customized quality control tasks for non-destructive testing, in accordance with aspects of the present disclosure.

FIG. 2 is an example computing system that may be used to implement the controller, the remote computing system, and/or the remote management system of FIG. 1.

FIG. 3 is an example interface that may be presented by the example remote management system of FIG. 1.

FIG. 4 is a flowchart representative of example machine readable instructions which may be executed by the example controller of FIG. 1 to control the magnetic particle testing system.

FIG. 5 is a flowchart representative of example machine readable instructions which may be executed by the example remote management system of FIG. 1 to provide remote management of the magnetic particle testing system of FIG. 1.

The figures are not necessarily to scale. Where appropriate, similar or identical reference numbers are used to refer to similar or identical components.

### DETAILED DESCRIPTION

Disclosed example systems and methods enable users, such as administrators, to remotely manage non-destructive testing (NDT) machine settings for testing different parts (referred to herein as recipes) on any or all managed NDT machines at once. Disclosed example systems store recipes from managed machines remotely, such as in a cloud-based system, and permits users to manage those recipes (e.g., add, delete, edit, etc.) through an interface on a remote computing device over a network. As used herein, the term “recipe” refers to a process or procedure, and the terms “recipe,” “process,” and “procedure” are used interchangeably.

Disclosed example systems and methods improve management of NDT machines, such as magnetic particle inspection systems, for administrators or other managers to alter machine methods without traveling to each managed machine. Administrators are provided with the ability to update and/or check test methods quickly and/or from anywhere, using a single portal. By implementing a client-server communication model, disclosed systems and methods may be implemented while avoiding lengthy information technology-related security procedures.

Disclosed example NDT systems include a test process manager and a magnetic particle inspection device or a penetrant testing device. The test process manager is configured to: receive a configuration of a magnetic particle test procedure or a penetrant test procedure corresponding to a part type; and store the magnetic particle test procedure or the penetrant test procedure. The magnetic particle inspection device or the penetrant testing device includes: a communications device configured to receive the magnetic particle test procedure or the penetrant test procedure from the test process manager via a communications network; a processor; and a memory coupled to the processor and storing machine readable instructions which, when executed, cause the processor to: in response to identification of the part type as a part under test, access the magnetic particle test procedure or the penetrant test procedure based on the identification; and control a testing process based on the magnetic particle test procedure or the penetrant test procedure.

In some examples, the test process manager is configured to receive the configuration from a user interface device communicatively coupled to the test process manager. In some examples, the instructions cause the processor to determine that an update to the magnetic particle test procedure or the penetrant test procedure is available from the test process manager and, in response to the determination, request an updated magnetic particle test procedure or an updated penetrant test procedure from the test process manager.

In some example systems, the test process manager is configured to receive a selection of the magnetic particle inspection device or the penetrant testing device for receipt of the magnetic particle test procedure or the penetrant test procedure. In some examples, the instructions cause the processor to receive an identification of the part type and, in response to the identification of the part type, request the magnetic particle test procedure or the penetrant test procedure from the test process manager via the communications device based on the part type.

In some examples, the instructions cause the processor to collect test data during the magnetic particle test procedure or the penetrant test procedure. In some examples, the instructions cause the processor to transmit the test data to the test process manager. In some examples, the test process manager is configured to store the test data in a database in association with at least one of an identifier of the part under test, an identifier of an operator who performed the test, an identifier of an owner of the part under test, a test customer identifier, an identifier of the magnetic particle inspection device or the penetrant testing device, an identifier of one or more pieces of equipment used to perform calibrations or quality checks on the magnetic particle inspection device or the penetrant testing device, a result of at least one of the calibrations or quality checks, or an identifier of a consumable product used to conduct the magnetic particle test procedure or the penetrant test procedure.

In some example systems, the test process manager is configured to, in response to a request for the test data, transmit the test data to a requesting device via a network. In some examples, the instructions cause the processor to transmit the test data at least one of: at a conclusion of a test; at a plurality of intervals; or in response to one or more events. In some examples, the test data including test results having at least one of an alphanumeric result or an indication of acceptability or unacceptability.

In some examples, the test process manager is configured to: transmit a test process interface to a computing device via a network; and receive the configuration of the magnetic particle test procedure or the penetrant test procedure from the computing device based on the test process interface. In some example systems, the test process interface includes executable instructions to generate the magnetic particle test procedure including at least one of: a number of magnetization shots, a magnetization shot time, a double magnetization, an extended demagnetization, a magnetization field type, current type, a magnetization amperage, a demagnetization amperage, a conductor length, a conductor size, a number of times a conductor is wrapped around the part under test, a wrap diameter of the conductor around the part under test, or a proximity of the conductor to an inspection location.

In some examples, the test process interface includes executable instructions to generate the penetrant test procedure including at least one of: a penetrant application technique, a penetrant dwell time, a rinse time, a rinse pressure, an emulsifier time, a drying time, a drying temperature, a developer application time, a developer coverage, or a developer dwell time. In some examples, the instructions cause the processor to send a request to the test process manager for an update to the magnetic particle test procedure or the penetrant test procedure, the request including an identifier of the magnetic particle inspection device, or the penetrant testing device.

In some examples, the test process manager is configured to: receive a definition of a quality verification procedure associated at least one of the magnetic particle test procedure, the penetrant test procedure, the magnetic particle inspection device, or the penetrant testing device; and transmit the quality verification procedure to the communications device. In some examples, the instructions cause the processor to: implement the quality verification procedure; and control at least one aspect of the magnetic particle test procedure, the penetrant test procedure, the magnetic particle inspection device, or the penetrant testing device based on a result of the quality verification procedure.

In some example systems, the instructions cause the processor to enable or disable operation of one or more components of the magnetic particle inspection device or the penetrant testing device in response to a result of the quality verification procedure. In some examples, the instructions cause the processor to store a result of the quality verification procedure in association a result of the testing process. In some examples, the instructions cause the test process manager to: provide an interface to enable input of the definition of the quality verification procedure; and determine the definition of the quality verification procedure based on the input to the interface.

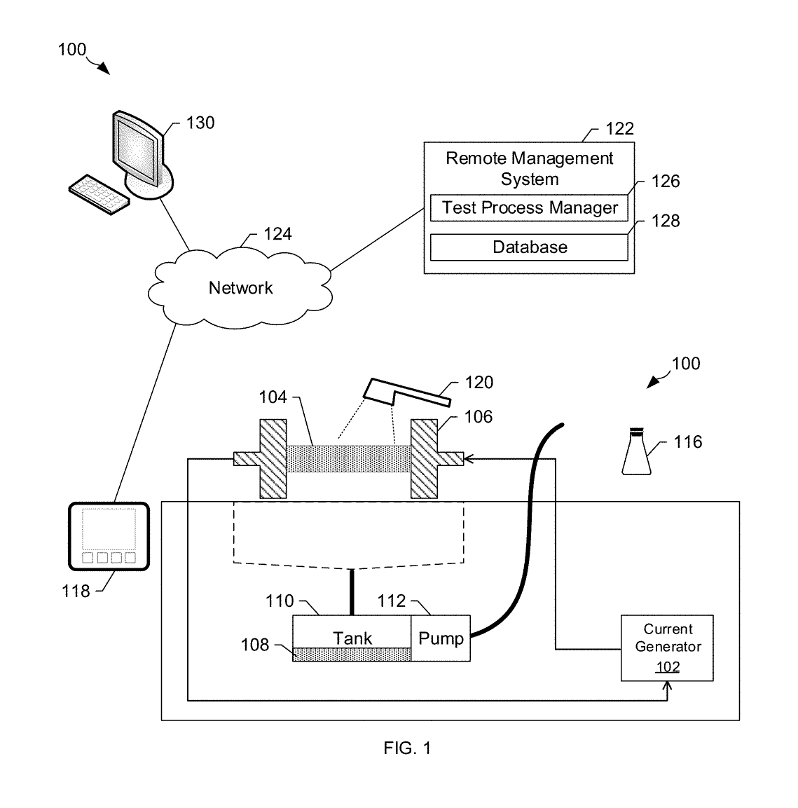

FIG. 1 shows an example magnetic particle testing system 100 configured to perform non-destructive testing and provide remote system management. The magnetic particle testing system 100 of FIG. 1 includes a current generator 102 that applies electrical current(s) to a to-be inspected part 104 via electrical contacts 106. In this regard, various magnetization approaches may be used to magnetize the inspected parts, with some systems allowing for selecting among such options. The magnetization may be achieved using, for example, AC (alternating current), half wave DC (direct current), or full wave DC (direct current). In some systems, a demagnetization function may be built into the system. For example, the demagnetization function may utilize a coil and decaying AC (alternating current).

During inspection, a wet magnetic particle solution 108 is applied to the part. The particle solution 108 (also called “bath”) may comprise visible or fluorescent particles that may be magnetized. The particle solution 108 may be collected and held in a tank 110. A pump 112 pumps the bath through a hose 114 to apply the particle solution 108 to the parts 104 being inspected (e.g., via a nozzle that is used in spraying the parts) and/or to collect samples of the particle solution 108 in a container 116 for contamination analysis. The magnetic particle testing system 100 may also incorporate a controller 118 to allow operators to control the system 100 and/or inspections. In this regard, the controller 118 may comprise suitable circuitry and input/output components, as described in more detail below.

After preparation of the part 104, magnetizing current is then applied by the current generator 102 to the part 104 via the electrical contacts 106. Application of the magnetizing current may be done for a short duration, and precautions may be taken to prevent burning or overheating of the part 104. The application of the magnetizing current to the part 104 via the electrical contacts 106 creates a magnetic field in the part 104 (e.g., a circular field flowing around the circumference of the part 104). The magnetic field allows detection of defects in the part 104. For example, when utilizing magnetic wet benches, with the part 104 wet from the magnetic solution, defects, such as cracks, may be detectable as a result of leakage fields from these defects, which attract the magnetic particles in the solution to form indications. Indications may be visually detectable using one or more lamps 120.

While not specifically shown in the particular implementation illustrated in FIG. 1, magnetic inspection machines may comprise additional parts, for performing other/different functions. For example, in some instances, test-related material may be used (e.g., applied to the inspected parts) during magnetic-based inspections, such as to enable and/or facilitate defect detection. These additional components or functions may be determined based on type of the machine and/or inspections performed using the machines.

To manage the example magnetic particle testing system 100, the example controller 118 may be communicatively coupled to a remote management system 122. For example, the controller 118 may be connected to the remote management system 122 via a communications network 124, such as the Internet, a wired local area network (LAN), a wide area network (WAN), and/or any other network, via one or more wired and/or wireless connections. The remote management system 122 includes a test process manager 126 and a database 128, and may be implemented using one or more dedicated servers, a cloud system, or any other data system and/or service.

The test process manager 126 enables configuration of magnetic particle testing recipes, which may be associated with particular parts. For example, the test process manager 126 may be accessed via the network 124 from a remote location such a remote computing device 130. As a result, the remote management system 122 permits remote management, configuration, and/or monitoring of the magnetic particle testing system 100, including configuration of recipes used for testing parts, without requiring an administrator to be physically present with the magnetic particle testing system 100.

The example database 128 stores magnetic particle testing recipes (e.g., configured via the test process manager 126) and/or magnetic particle testing results (e.g., received from the magnetic particle testing system 100). A magnetic particle testing recipe may be associated with a particular part identifier such that, when the particular part identifier is selected by an operator of the magnetic particle testing system 100, the corresponding magnetic particle testing recipe is automatically selected by the controller 118 and used to guide the operator and/or control the system 100 (e.g., the current generator 102).

In some examples, the controller 118 retrieves magnetic particle testing recipes based on parts and/or based on an association of a magnetic particle testing recipe with an identifier of the system 100. For example, the administrator of the system 100 may designate a particular recipe and corresponding test procedure to be performed on the system 100 and not on other magnetic particle inspection systems that may be controller by the administrator. The controller 118 may request updated recipes from the remote management system 122 periodically, in response to one or more events (e.g., when an operator logs into the system 100).

In response to identification of the part 104 as a part under test, the controller 118 accesses a corresponding recipe based on the identification and controls the magnetic particle testing process based on the recipe.

In some examples, the remote management system 122 is configured as a client-server system to reduce complexity at the controller 118. For example, the remote management system 122 may be configured to receive incoming requests from the controller 118 via the network 124 and to respond to the requests with the appropriate data. In this manner, the controller 118 (and any supporting communication infrastructure) is not required to expose open ports to a wide area network, which could increase the complexity of securing the controller 118 against network-based risks.

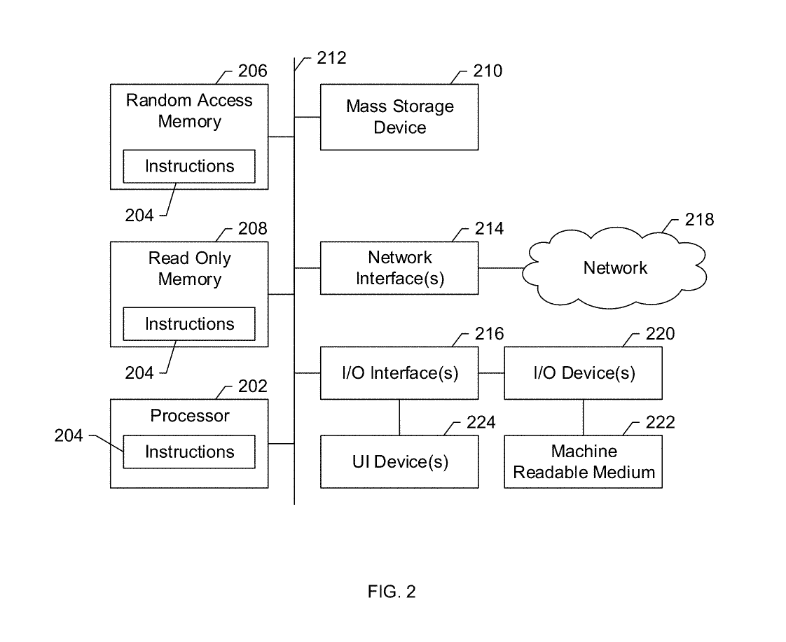

FIG. 2 illustrates an example computing system 200 which may be used to implement the example controller 118 and/or the example remote management system 122 of FIG. 1. The example computing system may be, for example, an integrated computing device, a desktop or all-in-one computer, a server, a laptop or other portable computer, a tablet computing device, a smartphone, and/or any other type of computing device.

The example computing system 200 includes a processor 202. The example processor 202 may be any general purpose central processing unit (CPU) from any manufacturer. In some other examples, the processor 202 may include one or more specialized processing units, such as RISC processors with an ARM core, graphic processing units, digital signal processors, and/or system-on-chips (SoC). The processor 202 executes machine readable instructions 204 that may be stored locally at the processor (e.g., in an included cache or SoC), in a random access memory 206 (or other volatile memory), in a read only memory 208 (or other non-volatile memory such as FLASH memory), and/or in a mass storage device 210. The example mass storage device 210 may be a hard drive, a solid state storage drive, a hybrid drive, a RAID array, and/or any other mass data storage device.

A bus 212 enables communications between the processor 202, the RAM 206, the ROM 208, the mass storage device 210, a network interface 214, and/or an input/output interface 216.

The example network interface 214 includes hardware, firmware, and/or software to connect the computing system 200 to a communications network 218 such as the Internet. For example, the network interface 214 may include IEEE 202.X-compliant wireless and/or wired communications hardware for transmitting and/or receiving communications.

The example I/O interface 216 of FIG. 1 includes hardware, firmware, and/or software to connect one or more user interface devices 220 to the processor 202 for providing input to the processor 202 and/or providing output from the processor 202. For example, the I/O interface 216 may include a graphics processing unit for interfacing with a display device, a universal serial bus port for interfacing with one or more USB-compliant devices, a FireWire, a field bus, and/or any other type of interface. The example computing system 200 includes a user interface device 224 coupled to the I/O interface 216. The user interface device 224 may include one or more of a keyboard, a keypad, a physical button, a mouse, a trackball, a pointing device, a microphone, an audio speaker, an optical media drive, a multi-touch touch screen, a gesture recognition interface, and/or any other type or combination of types of input and/or output device(s). While the examples herein refer to a user interface device 224, these examples may include any number of input and/or output devices as a single user interface device 224. Other example I/O device(s) 220 an optical media drive, a magnetic media drive, peripheral devices (e.g., scanners, printers, etc.), and/or any other type of input and/or output device.

The example computing system 200 may access a non-transitory machine readable medium 222 via the I/O interface 216 and/or the I/O device(s) 220. Examples of the machine readable medium 222 of FIG. 1 include optical discs (e.g., compact discs (CDs), digital versatile/video discs (DVDs), Blu-ray discs, etc.), magnetic media (e.g., floppy disks), portable storage media (e.g., portable flash drives, secure digital (SD) cards, etc.), and/or any other type of removable and/or installed machine readable media.

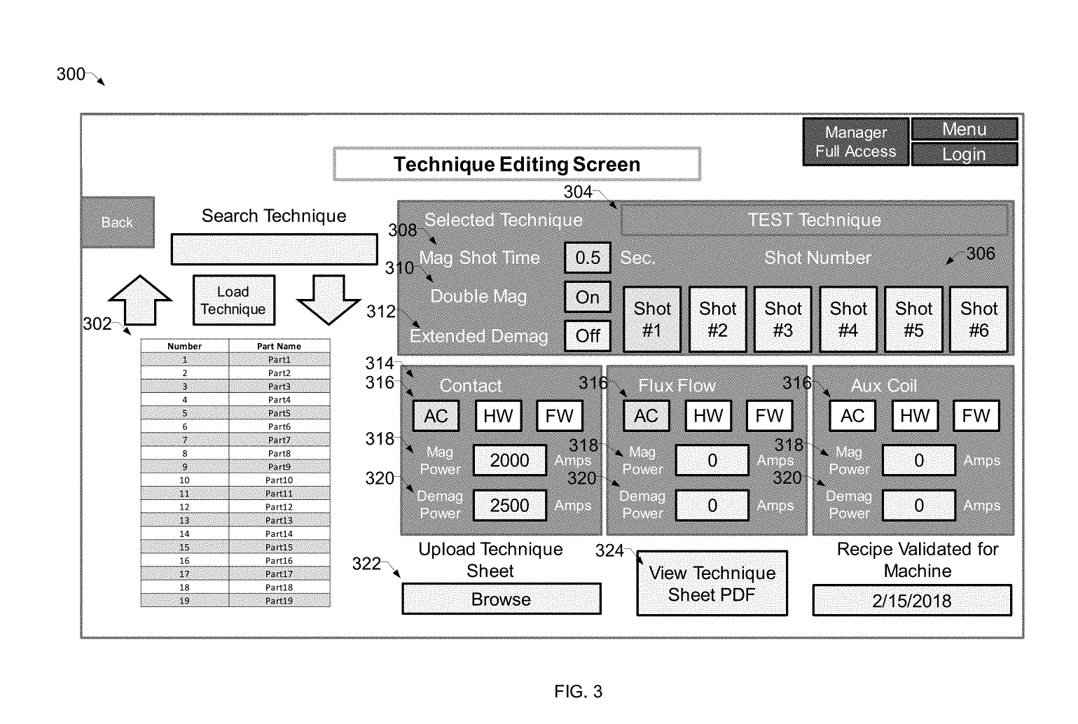

FIG. 3 is an example interface 300 that may be presented by the example remote management system 122 (e.g., via the test process manager 126) of FIG. 1. The interface 300 may be requested by the example remote computing device 130 of FIG. 1 and provided by the remote management system 122 for display at the remote computing device 130.

The example interface 300 includes a list of stored recipes 302, which may include recipes stored in the database 128. For example, the list of stored recipes 302 may list stored recipes by name or other identifier. In some examples, the list of stored recipes may be filtered and/or sorted by part number, magnetic particle testing system or penetrant testing device identifier, operator and/or administrator identifier, an identifier of an owner of the part under test, a test customer identifier, and/or any other criteria.

The interface 300 further includes options to define a name 304 of the recipe and to define a magnetic particle inspection procedure. The example recipes are defined in terms of a number of magnetization “shots,” or applications of magnetic fields to the part 104 via the contacts 106.

A number of shot selections 306 are included in the interface 300, where the shot selections 306 may be individually selected to define the characteristics of the corresponding current shot. As illustrated in FIG. 3, a first shot (“Shot #1) is selected, and corresponding characteristics of the shot, if previously defined, are populated in the interface 300. Example characteristics that may be defined for the shot include the magnetization shot time 308, double magnetization 310, extended demagnetization 312, magnetization field type 314, current type 316, magnetization amperage 318, and demagnetization amperage 320.

The magnetization shot time 308 determines the duration of current (specified in the magnetization amperage 318) applied to the part 104. The double magnetization 310 may be enabled to apply magnetization twice, with a short interval between the applications, or disabled. The extended demagnetization 312 may be enabled to extend the duration of a demagnetizing field for particular parts and/or strong magnetizations.

The magnetization field type 314 determines an orientation and/or location of the magnetic field, and may be selected from a contact shot (e.g., a longitudinal mag field), a flux flow shot (e.g., circular mag field originating from non-contact flux generators near or at the contacts 106), or an auxiliary coil shot (e.g., an operator-movable circular magnetic field. For each of the magnetization field types 314, the current polarity (e.g., AC, half-wave DC, full-wave DC) 316, the magnetization field strength (in current amperage) and the demagnetization strength (in current amperage) are also specified.

In some examples, the interface 300 enables an administrator to select a specific magnetic flux density (e.g., in Gauss) in the part 104, which is then used by the controller 118 to control the magnetization current (e.g., to control the current generator 102). An example of controlling the system 100 to provide a specified Gauss is disclosed in U.S. Provisional Patent Application Ser. No. 62/648,756, filed Mar. 27, 2018, entitled “Magnetic Inspection Machines with True Gauss Magnetic Measurements.” The entirety of U.S. Provisional Patent Application Ser. No. 62/648,756 is incorporated herein by reference.

The interface 300 further includes an upload button 322 to cause the remote management system 122 to designate one or more magnetic particle testing systems 100 for receipt of the recipe. In response to specifying the system 100 for receipt of the recipe, the example test process manager 126 associates the recipe with an identifier of the system 100. When the controller 118 request updated recipes from the remote management system 122, the example remote management system 122 selects the recipes associated with the system 100 from the database 128 and sends the recipes to the magnetic particle testing system 100 via the network 124.

The interface 300 also includes a technique sheet generator button 324, which enables an operator to view a technique sheet resulting from the defined recipe.

While FIGS. 1-3 are described with reference to magnetic particle testing using, for example, a magnetic wet bench and/or a power pack, the remote management system 122 may be used in conjunction with other types of non-destructive testing systems including, but not limited to, penetrant testing devices. For example, the remote management system 122 may enable configuration of additional or alternative parameters for magnetic particle inspection testing, such as a conductor length, a conductor size, a number of times a conductor is wrapped around the part under test, a wrap diameter of the conductor around the part under test, or a proximity of the conductor to an inspection location. For penetrant testing, the remote management system 122 may enable configuration of parameters such as a penetrant application technique, a penetrant dwell time, a rinse time, a rinse pressure, an emulsifier time, a drying time, a drying temperature, a developer application time, a developer coverage, or a developer dwell time.

In addition to providing interfaces for configuration of test procedures, the example test process manager 126 may provide an interface for defining quality verification procedures or checks (e.g., procedures to be performed and/or verified prior to performance of part testing). For example, the test process manager 126 may provide an interface to receive a definition of a quality verification procedure associated at least one of the magnetic particle test procedure, the penetrant test procedure, the magnetic particle inspection device, or the penetrant testing device. The test process manager 126 may then determine or generate a quality verification procedure based on the input to the interface (e.g., if the input does not completely define the procedure).

The test process manager 126 transmits the quality verification procedure to the controller 118 (e.g., the network interface 214 of FIG. 2), and the controller 118 implements the quality verification procedure based on the definition. Based on a result of the quality verification procedure, the controller 118 controls one or more aspects of the test equipment and/or one or more aspects of a testing process. For example, the controller 118 may enable or disable operation of one or more components of the magnetic particle inspection device or the penetrant testing device in response to a result of the quality verification procedure. For example, if the result of the quality verification procedure is not within acceptable limits (e.g., limits defined in the definition), the controller 118 may disable a component of the test equipment to prevent performance of part testing.

Additionally or alternatively, the controller 118 may store a result of the quality verification procedure in association a result of the testing process.

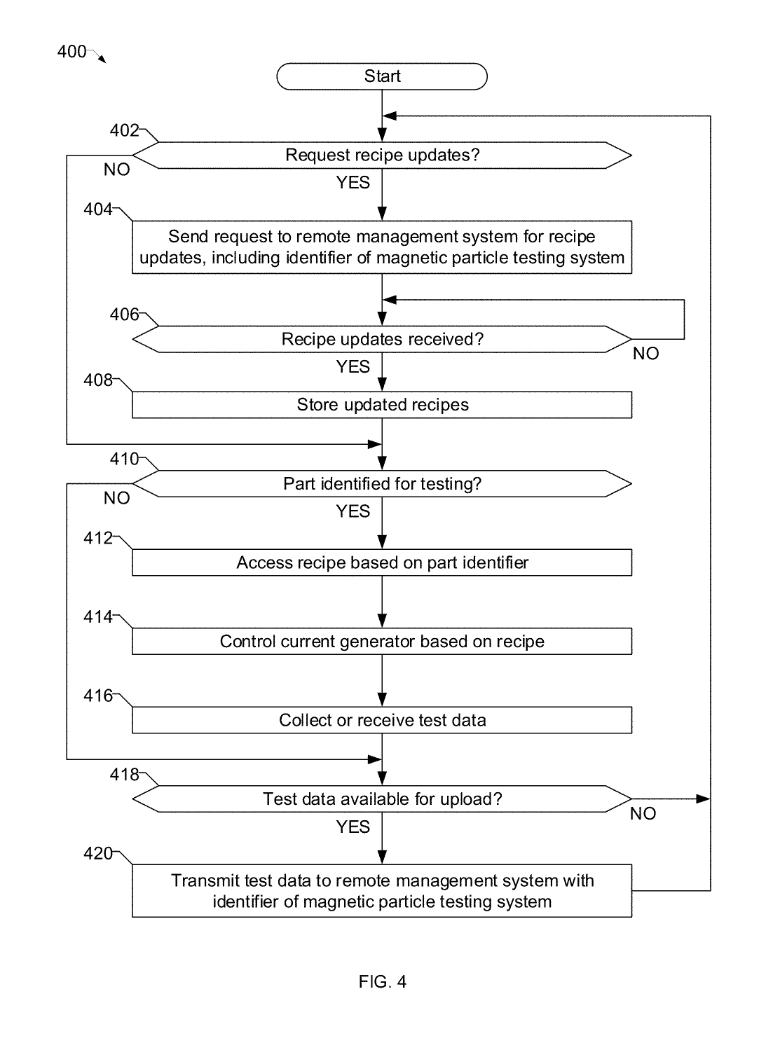

FIG. 4 is a flowchart representative of example machine readable instructions 400 which may be executed by the example controller 118 of FIG. 1 to control the magnetic particle testing system 100. The example instructions 400 may be executed by the example computing system 200 implementing the controller 118.

At block 402, the controller 118 determines whether to request recipe updates. For example, recipe updates may be requested from the remote management system 122 periodically (e.g., every day), aperiodically (e.g., at the start of a shift) in response to an event (e.g., in response to an operator logging into the controller 118), and/or any other time. If recipe updates are to be requested (block 402), at block 404 the controller 118 sends a request to the remote management system 122 (e.g., via the network 124) for recipe updates. The request may include an identifier of the magnetic particle testing system 100, an identifier of an operator, configuration information of the magnetic particle testing system 100, and/or any other information that may be used to determine recipes to be provided to the magnetic particle testing system 100.

At block 406, the controller 118 determines whether recipe updates have been received. If recipe updates have not been received (block 406), control may iterate at block 406 until a timeout is reached, after which the controller 118 may proceed or request the recipe updates again. When recipe updates are received (block 406), at block 408 the controller 118 stores the updated recipes (e.g., in the mass storage device 210 of FIG. 1, in a removable storage device, etc.).

After storing the updated recipes (block 408), or if recipe updates are not requested (block 402), at block 410 the controller 118 determines whether a part has been identified for testing via the magnetic particle testing system 100. For example, the controller 118 may receive an operator input and/or input from a peripheral device, such as an RFID reader or a barcode scanner.

If a part has been identified (block 410), at block 412 the controller 118 accesses a recipe based on the part identifier. At block 414, the controller 118 controls the current generator 102 based on the recipe. For example, the controller 118 may control the current generator 102 to output one or more magnetization shots to the part 104 as defined in a recipe corresponding to the part identifier. At block 414, the controller 118 collects or receives test data, such as data representative of whether indications were identified for the tested part 104.

After collecting or receiving the test data (block 416), or if a part is not identified for testing (block 410), at block 418 the controller 118 determines whether test data is available for upload. For example, the controller 118 may upload part test results at the conclusion of a test, at intervals, and/or in response to one or more events (e.g., prior to the operator logging off of the controller 118). If test data is available for upload (block 418), at block 420 the controller 118 transmits the test data to the remote management system 122. The controller 118 may transmit additional data corresponding to the test data, such as a serial number or other identifier of the part 104 under test, an identifier of the operator who performed the test, an identifier of the magnetic particle testing system 100, an identifier of one or more pieces of equipment used to perform calibrations or quality checks on the magnetic particle testing system 100, an identifier of a consumable product used to conduct the test, an identifier of an owner of the part under test, a test customer identifier, an identifier of the magnetic particle inspection device or the penetrant testing device, a result of at least one of the calibrations or quality checks, and/or any other data that may be relevant or useful for later identifying the circumstances of the test.

After transmitting the data (block 420), or if no test data is available for upload (block 418), control returns to block 402.

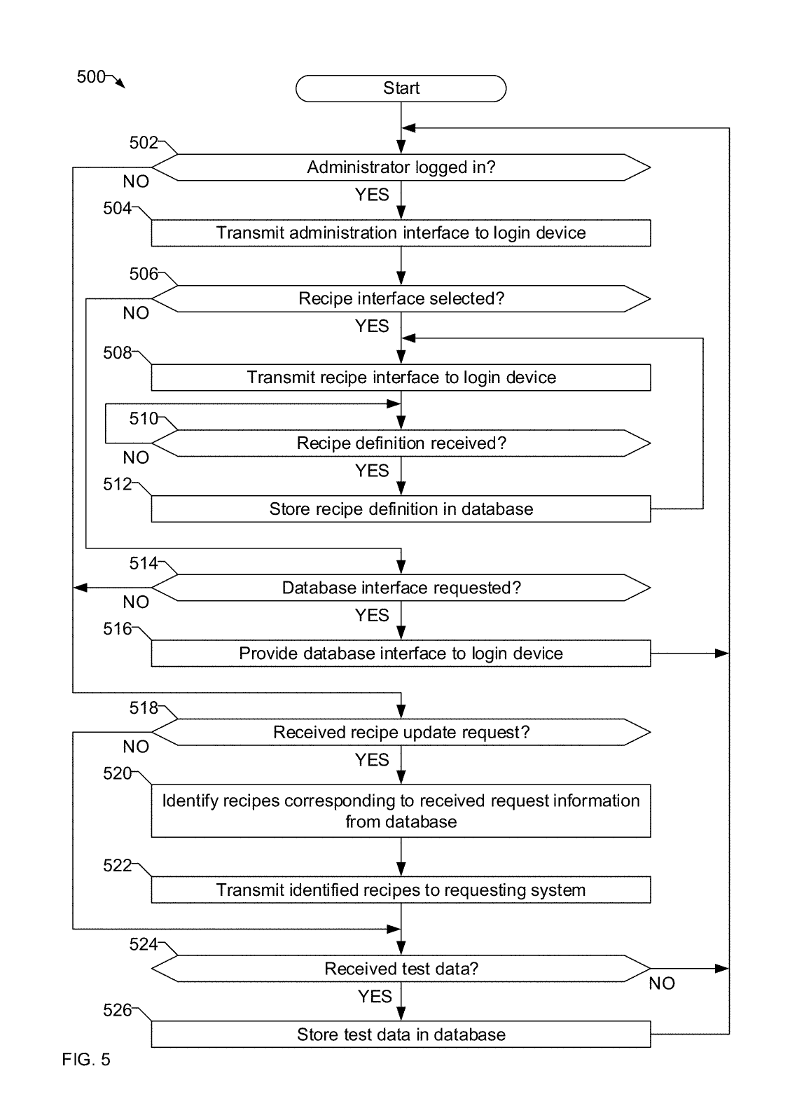

FIG. 5 is a flowchart representative of example machine readable instructions 500 which may be executed by the example remote management system 122 of FIG. 1 to provide remote management of the magnetic particle testing system 100 of FIG. 1. The example instructions 400 may be executed by the example computing system 200 implementing the remote management system 122.

At block 502, the remote management system 122 determines whether an administrator has logged in. A login may be received from the remote computing device 130 of FIG. 1. An administrator may be, for example, a user authorized to access one or more remote management functions of one or more magnetic particle testing systems via the remote management system 122, such as modifying recipes, assigning recipes to magnetic particle testing systems, accessing test data, and/or any other functions. If an administrator has logged in (block 502), at block 504 the remote management system 122 transmits an administration interface to a login device, such as the remote computing device 130. An example administration interface may include a web page or other interface and/or program that enables the administrator to select one or more authorized functions. Example functions include creating, modifying, and/or deleting recipes via a recipe interface, and/or accessing test data stored in the database 128.

At block 506, the remote management system 122 determines whether a recipe interface has been selected by the administrator. The recipe interface may be, for example, a formatted HTML page, a response to a call from an application programming interface (API), or any other format. The recipe interface may include scripts, links, and/or other executable instructions that permit a user of the recipe interface to request and/or transmit recipe data to the remote management system 122. For example, the executable instructions may cause the executing device (e.g., the remote computing device 130) to present the recipe interface 300 described above with reference to FIG. 3, or an interface including some or all of the components of the recipe interface 300. If the recipe interface has been selected (block 506), at block 508 the test process manager 126 transmits a recipe interface to the login device. An example recipe interface 300 that may be provided is described above with reference to FIG. 3.

At block 510, the test process manager 126 determines whether a recipe definition has been received (e.g., from the remote computing device 130). If a recipe definition has not been received (block 510), the test process manager 126 may iterate block 510 to await a recipe definition and/or, if the administrator has closed the recipe interface, return control to block 504. When a recipe definition is received (block 510), at block 512 the test process manager 126 stores the recipe definition in the database 128. The test process manager 126 may store additional information with the recipe definition, such as authorized or assigned magnetic particle testing systems and/or operators, and/or parts for which the recipe is to be used for testing. Control then returns to block 508.

When a recipe interface has not been selected (block 504), at block 514 the remote management system 122 determines whether a database interface has been requested. If the database interface has been requested (block 514), at block 516 the example remote management system 122 provides a database interface to the login device. The database interface may enable the administrator to query stored test data and retrieve resulting test data. Additionally or alternatively, the database interface may enable an administrator to performance data analyses on the stored test data. When the administrator is finished with the database interface (block 516), control may return to block 502.

When the database interface has not been requested (block 514), at block 518 the remote management system 122 determines whether a recipe update request has been received (e.g., from a magnetic particle testing system). The recipe update request may include, for example, an identifier of the requesting system, an identifier of an operator, identifiers of one or more parts to be tested, and/or any other information that may be used to identify relevant recipes.

If a recipe update request has been received (block 518), at block 520 the test process manager 126 identifies recipes corresponding to the received request information from the database 128. At block 522, the test process manager 126 transmits identified recipes to the requesting magnetic particle testing system.

After transmitting identified recipes (block 522), or if no recipe update requests have been received (block 518), at block 524 the remote management system 122 determines whether test data has been received. If test data has been received (block 524), at block 526 the remote management system 122 stores the test data in the database 128. The example remote management system 122 stores the test data in association with any additional data that may be received with the test data, such as an operator identifier, a system identifier, a recipe identifier, and/or quality check information. After storing the test data (block 526), or if test data is not received (block 524), control returns to block 502.

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. A non-destructive testing (NDT) system, comprising:
a test process manager configured to:
receive a configuration of a magnetic particle test procedure or a penetrant test procedure corresponding to a part type; and
store the magnetic particle test procedure or the penetrant test procedure; and
a magnetic particle inspection device or penetrant testing device, comprising:
a communications device configured to receive the magnetic particle test procedure or the penetrant test procedure from the test process manager via a communications network;
a processor; and
a memory coupled to the processor and storing machine readable instructions which, when executed, cause the processor to:
in response to identification of the part type as a part under test, access the magnetic particle test procedure or the penetrant test procedure based on the identification; and
control a testing process based on the magnetic particle test procedure or the penetrant test procedure.

2. The NDT system as defined in claim 1, wherein the test process manager is configured to receive the configuration from a user interface device communicatively coupled to the test process manager.

3. The NDT system as defined in claim 1, wherein the instructions, when executed, cause the processor to determine that an update to the magnetic particle test procedure or the penetrant test procedure is available from the test process manager and, in response to the determination, request an updated magnetic particle test procedure or an updated penetrant test procedure from the test process manager.

4. The NDT system as defined in claim 1, wherein the test process manager is configured to receive a selection of the magnetic particle inspection device or the penetrant testing device for receipt of the magnetic particle test procedure or the penetrant test procedure.

5. The NDT system as defined in claim 1, wherein the instructions, when executed, cause the processor to receive an identification of the part type and, in response to the identification of the part type, request the magnetic particle test procedure or the penetrant test procedure from the test process manager via the communications device based on the part type.

6. The NDT system as defined in claim 1, wherein the instructions, when executed, cause the processor to collect test data during the magnetic particle test procedure or the penetrant test procedure.

7. The NDT system as defined in claim 6, wherein the instructions, when executed, cause the processor to transmit the test data to the test process manager.

8. The NDT system as defined in claim 7, wherein the test process manager is configured to store the test data in a database in association with at least one of an identifier of the part under test, an identifier of an operator who performed the test, an identifier of an owner of the part under test, a test customer identifier, an identifier of the magnetic particle inspection device or the penetrant testing device, an identifier of one or more pieces of equipment used to perform calibrations or quality checks on the magnetic particle inspection device or the penetrant testing device, a result of at least one of the calibrations or quality checks, or an identifier of a consumable product used to conduct the magnetic particle test procedure or the penetrant test procedure.

9. The NDT system as defined in claim 7, wherein the test process manager is configured to, in response to a request for the test data, transmit the test data to a requesting device via a network.

10. The NDT system as defined in claim 7, wherein the instructions, when executed, cause the processor to transmit the test data at least one of: at a conclusion of a test; at a plurality of intervals; or in response to one or more events.

11. The NDT system as defined in claim 7, wherein the test data comprises test results comprising at least one of an alphanumeric result or an indication of acceptability or unacceptability.

12. The NDT system as defined in claim 1, wherein the test process manager is configured to:
transmit a test process interface to a computing device via a network; and
receive the configuration of the magnetic particle test procedure or the penetrant test procedure from the computing device based on the test process interface.

13. The NDT system as defined in claim 12, wherein the test process interface comprises executable instructions to generate the magnetic particle test procedure including at least one of: a number of magnetization shots, a magnetization shot time, a double magnetization, an extended demagnetization, a magnetization field type, current type, a magnetization amperage, a demagnetization amperage, a conductor length, a conductor size, a number of times a conductor is wrapped around the part under test, a wrap diameter of the conductor around the part under test, or a proximity of the conductor to an inspection location.

14. The NDT system as defined in claim 12, wherein the test process interface comprises executable instructions to generate the penetrant test procedure including at least one of: a penetrant application technique, a penetrant dwell time, a rinse time, a rinse pressure, an emulsifier time, a drying time, a drying temperature, a developer application time, a developer coverage, or a developer dwell time.

15. The NDT system as defined in claim 1, wherein the instructions, when executed, cause the processor to send a request to the test process manager for an update to the magnetic particle test procedure or the penetrant test procedure, the request including an identifier of the magnetic particle inspection device, or the penetrant testing device.

16. The NDT system as defined in claim 1, wherein the test process manager is configured to:
receive a definition of a quality verification procedure associated at least one of the magnetic particle test procedure, the penetrant test procedure, the magnetic particle inspection device, or the penetrant testing device; and
transmit the quality verification procedure to the communications device.

17. The NDT system as defined in claim 16, wherein the instructions, when executed, cause the processor to:
implement the quality verification procedure; and
control at least one aspect of the magnetic particle test procedure, the penetrant test procedure, the magnetic particle inspection device, or the penetrant testing device based on a result of the quality verification procedure.

18. The NDT system as defined in claim 16, wherein the instructions, when executed, cause the processor to enable or disable operation of one or more components of the magnetic particle inspection device or the penetrant testing device in response to a result of the quality verification procedure.

19. The NDT system as defined in claim 16, wherein the instructions, when executed, cause the processor to store a result of the quality verification procedure in association a result of the testing process.

20. The NDT system as defined in claim 16, wherein the instructions, when executed, cause the test process manager to:
provide an interface to enable input of the definition of the quality verification procedure; and
determine the definition of the quality verification procedure based on the input to the interface.
